(19) United States
(12) Patent Application Publication
(10) Pub. No.: US 2003/0170605 A1
(43) Pub. Date: Sep. 11, 2003

(54) Vapor deposited writing surfaces

(75) Inventors: Jim Long, Woodbridge (CA); Steve Kaplan, San Carlos, CA (US); Gregg Steliga, North Barrington, IL (US)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Egan Visual Inc., Woodbridge (CA)

(21) Appl. No.: 10/093,964

(22) Filed: Mar. 11, 2002

(51) Int. Cl. B43L 1/12

(52) U.S. Cl. 434/410

(57) ABSTRACT

A writing surface, such as they be used for white board, is produced by vapor deposition of a thin ceramic film on a substrate.

### FIELD OF THE INVENTION

The present invention relates generally to thin films for writing surfaces, and methods for depositing and using same.

### BACKGROUND OF THE INVENTION

A whiteboard, also commonly referred to as a dry erase board or an erasable marker board, may be used to display written marker images and/or video projected images. One type of conventional whiteboard comprises a flexible plastic substrate that is mounted on a backing layer. This type of writing surface only moderately resists the acidic solvents contained in dry erase markers. As a result, the writing surface tends to degrade over time. This lack of impermeability also causes some of the dry erase ink to be retained on the writing surface after being erased with a dry eraser. This is commonly referred to as ‘ghosting’. Thus, cleaning solvents may be required to provide a more thorough cleaning of the writing surface. This type of writing surface also tends to be vulnerable to wear and abrasion damage. More specifically, the friction of the dry eraser on the relatively soft writing surface may induce scratching and/or hazing. All of these factors tend to result in permanent staining of the writing surface. These shortcomings severely limit the usefulness and lifespan of this type of whiteboard.

Another type of conventional whiteboard comprises a porcelain enamel film coated onto the surface of a steel substrate that is mounted on a backing layer. The porcelain film is a vitreous ceramic that has a relatively hard ‘glass-like’ surface. This type of writing surface is substantially impervious to the acidic solvents contained in dry erase markers. As such, dry erasers may be used to easily remove the dry erase ink from the writing surface with minimal ‘ghosting’. Moreover, these writing surfaces tend to be fairly resistant to wear and abrasion damage. However, these types of writing surfaces tend to be relatively heavy since porcelain films are typically only applied to steel substrates. Moreover, these writing surfaces tend to be difficult and costly to fabricate. Furthermore, these writing surfaces are vulnerable to fracture and/or chipping if inadvertently flexed during handling.

Lesser quality erasable boards have been fabricated using plastic film or plastic composites as the writing surface. See for example U.S. Pat. No. 5,361,164. These products usually represent the trade off of erasability, ghosting (that can be severe with permanent staining), and surface toughness (i.e. scratching and heaving are hazing and used).

### SUMMARY OF THE INVENTION

In accordance with the instant invention a writing surface comprises a thin ceramic film on a substrate. The thin ceramic film may be deposited by plasma enhanced chemical vapor deposition or by physical vapor deposition. Plasma enhanced chemical vapor deposition employs plasma energy to fragment organo-silane, siloxane compounds or the like in the gas phase so as to deposit a silicon oxide material on to the surface of a substrate which is exposed to the plasma thereby forming a glass like film. The physical vapor deposition process (sputtering) is a physical process whereby a target material (e.g. silica) is vaporized either by an e-beam, an ion beam or the like such that on a microscopic level, small bits of the silica sputters and coats the surface of the substrate thereby forming a glass like film.

In accordance with another embodiment of the instant invention an erasable marker board having an outer surface that is usable for writing with a dry erasable marker, the board comprises:

(a) a substrate having a first surface and a second surface opposed to the first surface; and,

(b) a thin film of SiOₓ provided on the first surface of the substrate and comprising the outer surface of the board.

In one embodiment, x is <2, preferably 1.5<x<2.0 and more preferably 1.5<x<1.95.

In another embodiment, the thin film comprises a ceramic.

In another embodiment, the thin film includes carbon. Preferably, the carbon content the thin film varies from 5 to about 10 atomic weight percent based on the weight of the thin film and more preferably is about 7 atomic atomic weight percent based on the weight of the thin film.

In another embodiment, at least some of the SiOₓ in the thin film comprises SiOₓC_{y}:H.

In another embodiment, the thin film is prepared by vapor deposition.

In another embodiment, the thin film is prepared by plasma enhanced chemical vapor deposition utilizing a silicon oxide precursor.

In another embodiment, the thin film is prepared by physical vapor deposition utilizing SiO₂ as a target material.

In accordance with another embodiment of the instant invention, there is provided the use of a thin film of SiOₓ as a writing surface of a board. Preferably, 1.5<x is <2 and more preferably 1.8<x<2.0.

In accordance with another embodiment of the instant invention, there is provided a method of fabricating a erasable marker board having an outer writing surface, the method comprising the steps of:

(a) providing a substrate;

(b) providing a thin ceramic film on the substrate as the outer writing surface of the board.

In one embodiment, the thin film is produced by vapor deposition.

In another embodiment, the vapor deposition comprises:

(a) providing at least one feed gas stream comprising at least one silicon oxide precursor;

(b) forming a plasma in an evacuated chamber;

(c) providing the substrate in flow communication with the plasma; and,

(d) flowing the gas stream into the plasma to deposit the thin film onto the substrate wherein the thin film comprises SiOₓ.

In another embodiment, the method further comprises providing carbon to the plasma wherein at least some of the SiOₓ is SiOₓC_{y}:H.

In another embodiment, oxygen oxidizes the silicon oxide precursor and the method further comprises providing oxygen to the plasma to produce a plasma having a concentration of oxygen therein and adjusting the concentration of the oxygen in the plasma to control the extent of oxidation of the silicon oxide precursor.

In another embodiment the silicon oxide precursor is one or more of hexamethyldisiloxane, tetramethyidisiloxane and tetramethylsilane.

In another embodiment, the vapor deposition comprises physical vapor deposition.

In another embodiment the vapor deposition comprises:

(a) providing a target material in a chamber;

(b) providing a substrate in the chamber;

(c) vaporizing at least a portion of the target material to obtain vaporized target material and depositing a thin film of the vaporized target material onto the surface of the substrate thereby forming the top outer writing surface.

In another embodiment, the target material comprises SiO₂.

In another embodiment, the method further comprises passing at least some of the vaporized target material through a plasma field in the presence of a gas prior to the vaporized target material being deposited onto the substrate. The gas may be an inert gas. Preferably, the inert gas is selected from the group consisting of argon, helium, xenon and mixtures thereof. Alternately, the gas may be selected from the group consisting of oxygen, methane, hydrogen, carbon dioxide, nitrogen oxide and mixtures thereof.

### BRIEF DESCRIPTION OF THE DRAWINGS

For a better understanding of the present invention, and to show more clearly how it may be carried into effect, reference will now be made, by way of example, to the accompanying drawings, which show preferred embodiments of the present invention and in which:

FIG. 1a is cross-sectional view of a writing surface according to one embodiment of the present invention;

FIG. 1b is cross-sectional view of a writing surface according to another embodiment of the present invention;

FIG. 2 is a schematic diagram of a conventional plasma enhanced vapor deposition process; and, FIG. 3 is a schematic diagram of a conventional dual chamber web coating apparatus using vacuum evaporation as the deposition process for performing physical vapor deposition (sputtering).

### DESCRIPTION OF THE PREFERRED EMBODIMENT

The present convention provides a writing surface that utilizes a thin ceramic film for receiving an image such as may be applied manually by a person writing with a dry erase marker. The thin film is applied to a substrate. The substrate provides a structural backing to support the thin film and prevent it from creasing, cracking, rippling or otherwise being marked in such a way as to make the film unsuitable for receiving an image. In one preferred embodiment, the writing surface comprises an erasable marker board and, more preferably, a dry erasable marker board. Examples of such boards include white boards. It will be appreciated that the writing surface may be incorporated into other articles of commerce that may benefit from incorporating therein an erasable writing surface, such as a wall, cabinet, stand or the like. The writing surface may be mounted onto solid boards or hollow frames. Furthermore, the writing surface may be supplied with a self-adhering backing that may be removed and placed directly onto the surface of a wall or the like.

The writing surface in accordance with the instant invention is also suitable for receiving projected images such as video projection images. Preferably, the writing surface has a low gloss level to enhance the viewing of video projection images. This may be achieved by utilizing a non-glare substarte

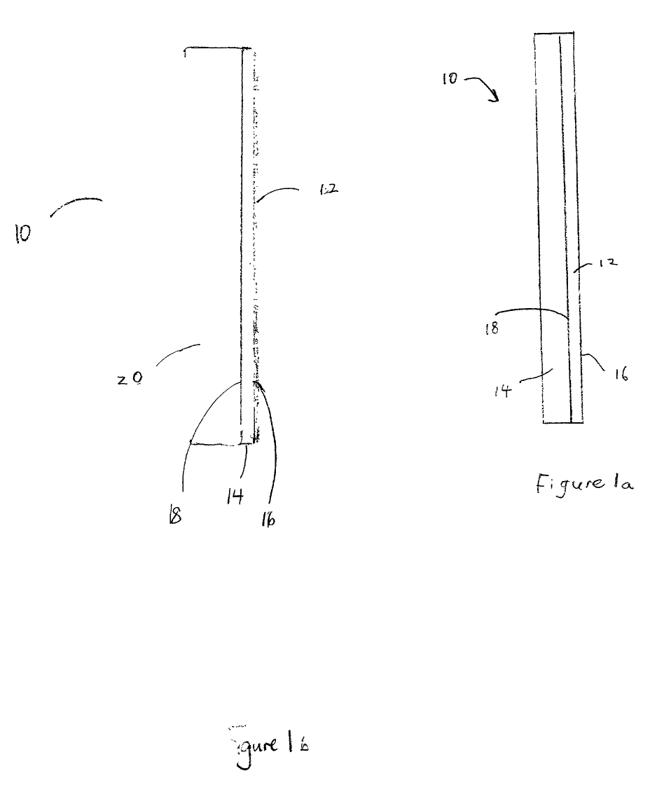

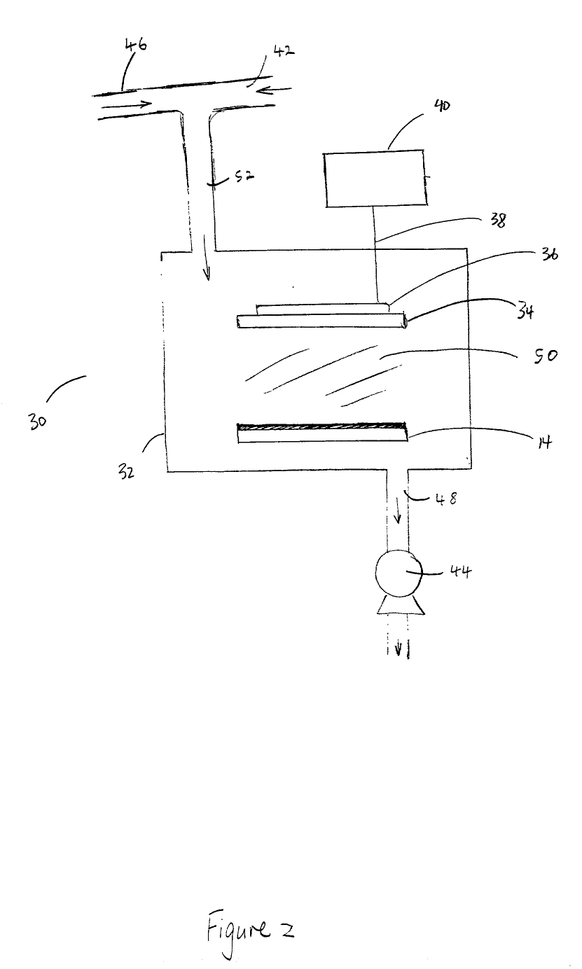

Referring to the preferred embodiment of FIG. 1a, a cross-sectional view of a writing surface of the present invention is shown generally at 10. The writing surface 10 generally comprises a thin film 12 and a substrate 14. Substrate 14 has a first surface 16 and a second surface 18 opposed to the first surface 16. Thin film 12 defines the top layer or outer surface of the writing surface 10, and is provided on the first surface 16 of the substrate. Referring to the preferred embodiment of FIG. 1b, writing surface 10 optionally includes a support layer 20 that is affixed to substrate 14 such as by means of adhesive layer 22. The adhesive layer 22 is interposed between the second surface 18 of the substrate 14 and the support layer 20.

Support layer 20 may be provided if substrate 14 does not provide sufficient dimensional stability to thin film 12 to permit thin film 12 to be written on or otherwise marked without being damaged, buckling, creasing or the like. As used hereinafter, “substrate” is used to refer to the physical support of thin film 12 which may include optional support layer 20 as desired.

The thin film 12 may be deposited onto the first surface 16 of the substrate 14 using any thin film vapor deposition method well known in the art. Thin film 12 may be deposited using a physical vapor deposition process (e.g., sputtering) or by a plasma enhanced chemical vapor deposition (PECVD). Preferably, the thin film has a thickness of from about 0.02μ to about 2μ, more preferably from about 0.04μ to about 1μ and most preferably from about 0.05μ to about 0.2μ.

The thin film may comprise a ceramic such as SiOₓ, SiC, a combination of SiOₓ and SiC, or MgOₓ or the like. Preferably, the thin film comprises a silicon oxide (SiOₓ), such as silicon dioxide (SiO₂). More preferably, the thin film comprises a silicon suboxide that is generally of the formula of SiOₓ, where x is less than 2. In such an embodiment X is preferably in the range from 1.5 to 1.95, preferably in the range 1.6 to 1.9 and most preferably 1.7-1.8.

Sputtering results in the vaporization of material, which is subsequently deposited on the substrate whereas PECVD generates a material to be deposited from a feed gas stream. The PECVD process allows more control of the chemistry of the thin film that is deposited on the substrate (i.e. it permits the chemical composition of the deposited layer to be adjusted). Thus PECVD is therefore a more preferred process as it permits finer adjustment of the film properties providing an improved balance of the desired properties of the thin film.

In one embodiment, thin film 12 also includes carbon. It has been discovered that including some carbon in the thin film reduces the drag against either the marker or the eraser as compared to a surface containing only SiOₓ. This results in a smoother application of an image by means of a marker and more complete removal of an image by a dry eraser. For example, hydrocarbon molecule fragments such as CH₂ and CH₃ may be included such that at least a portion of the thin film is of the formula SiOₓC_{y}:H. This may be achieved by using precursors such as SiCl₄, SiH₄, (CH₃)₄Si, (CH₃)₂SiOSi(CH₃)₂ and (CH₃)₃SiOSi(CH₃)₃ (hexamethydisiloxane) as at least a portion of the feed gas to a PECVD process.

The carbon content in the thin film is related to the ease with which the dry erase markings may be erased from the writing surface. The retention of some carbon in the thin film tends to reduce the coefficient of friction, and increase the ease of erasing the writing surface. However, in cases where the carbon content is too high, the chemical barrier may be weakened and the writing surface may be prone to ghosting. Preferably, the carbon content of thin film 12 varies from 5 to about 10 and more preferably is about 7 atomic weight percent based on the weight of thin film 12.

Preferably, the substrate 14 is a substantially opaque and relatively flexible material. More preferably, the substrate 14 is comprised of a plastic. Alternatively, the substrate 14 may be comprised of a paper coated with a plastic. Examples of plastics include, but are not limited to, one or a combination of polypropylene, polyethylene, or polyester. These substrates may be thin films (e.g. from 0.25 mm to 10 mm thick), they may have a glossy or matte surface and they may be pigmented if desired. Preferably, the substrate 14 is substantially reflective of light, thus allowing the video projected images to be adequately viewed by an individual. Examples of such substrates include, but are not limited to, pigmented or unpigmented, textured or untextured films of polyamides, polyesters, polypropylenes, polyvinylchlorides, polystyrenes, polycarbonate and alloys or copolymers thereof. It will be appreciated that the thickness of the substrate will vary depending upon the use of the final product, and whether a support layer 20 is included.

The adhesive layer may be a chemical adhesive, such as an epoxy or urethane adhesive, or a pressure sensitive adhesive such as an acrylic or silicone adhesive. Preferably, the adhesive layer 22 is a pressure sensitive adhesive. Thus, the second surface 18 of the substrate 14 may be easily adhered to the support layer 20. Alternatively, the adhesive layer 22 may be used to apply the writing surface directly onto a wall, cabinet, stand or the like.

The support layer 20 may be comprised of any suitable solid material such as cardboard, plastic, wood, sheet metal or the like. Alternatively, the support layer 20 may be comprised of a hollow frame. In either case, the support layer 20 provides a relatively hard surface for mounting the relatively flexible substrate 14.

Writing surfaces prepared in accordance with the instant invention provide equivalent performance as porcelain boards which are known in the art. This is achieved by applying a thin film that has a relatively hard ‘glass-like’ writing surface to a dimensionally stable backer or support. The thin film provides a surface having one or more of the following properties:

(a) Substantially imperviousness to dry erase marker ink, thereby allowing dry erase ink to be easily removed from the writing surface by a dry eraser with negligible ‘ghosting’.

(b) Substantially imperviousness to cleaning solvents such as an alcohol (e.g. isopropanol), or acetone.

(c) Substantially imperviousness to permanent marker ink, thereby allowing the permanent ink to be easily removed from the writing surface with the use of cleaning solvents.

(d) Resistance to wear and abrasion that may be caused by the friction of the marker or the dry eraser on the writing surface. The physical arrangement of the specific coating apparatus that is used determines the density of the deposited coating. Preferably, the density of the coating is increased so as to increase the abrasion resistance. For example, the use of a magnetron arrangement to focus the plasma energy, as well as argon ions, may be used to increase the deposition rate as well as to produce a denser film during PECVD deposition. Preferably, the thin film has a density from about 1.8 g/cc to about 2.65 g/cc, more preferably from about 2.0 g/cc to about 2.65 g/cc and, most preferably, from about 2.2 g/cc to about 2.5 g/cc.

(e) Resistance to chipping and/or fracturing, which may be caused by inadvertent flexing during handling.

(f) A substantially colorless writing surface.

(h) A smooth surface having a low drag co-efficient, permitting the marker to glide easily along the writing surface.

(i) A surface with a low gloss level sufficient to permit video projection with a minimal amount of reflection (commonly referred to as hotspots).

As discussed previously, in accordance with one embodiment of this invention, thin film 12 may be deposited onto the first surface 16 of the substrate by plasma enhanced chemical vapor deposition (which is also known as plasma polymerization and plasma deposition). This method generally employs plasma energy to fragment a gas stream comprising one or more silicon oxide (SiOₓ) precursors. Silicon oxide (SiOₓ) precursors are those materials that result in the deposition of a silicon oxide material, and preferably a silicon suboxide material, on a substrate. As a result of the process, a silicon oxide material, and preferably a silicon suboxide material, is deposited in-situ onto the surface of a substrate that is provided in flow communication with the plasma.

The feed material may be one or more organo-silanes and/or one or more organo-siloxanes. The feed material for the gas stream fed to the process may be a liquid at about ambient temperature, and have a boiling point above about ambient temperature. Among the preferred silicon oxide precursors are organosilane compounds and, in particular, hexamethyl disiloxane (HMDSO), tetramethyl disiloxane (TMDSO), or tetramethyl silane (TMS).

Other compounds may be or include, but are not limited to, one or more of methylsilane, dimethylsilane, trimethylsilane, diethylsilane, propylsilane, phenylsilane, hexamethyldisilane, 1,1,2,2-tetramethyldisilane, bis(trimethylsilyl) methane, bis(dimethylsilyl)methane, hexamethylsiloxane, vinyltrimethoxysilane, vinyltriethoxysilane, ethylmethoxysilane, ethylmethoxy silane, divinyltetramethyldisiloxane, divinylhexamethyltrisiloxane, and trivinylpentamethyltrisiloxane.

Plasma is a partially ionized gas consisting of large concentrations of excited atomic, molecular, ionic and free-radical species. Excitation of the gas molecules is accomplished by subjecting the gas, which is enclosed in a vacuum chamber, to an electric field. The free electrons in the plasma gain energy from the imposed radio frequency field, and collide with neutral gas molecules. This transfers energy from the electrons to the neutral gas molecules, and dissociates the molecules into numerous excited species. This sets off a ‘chain reaction’ that, in turn, produces a suitable reactive plasma. It is the interaction of these excited species with the substrate placed in the plasma that results in the chemical and physical modifications of the substrate surface 14. Any PECVD process known in the art may be utilized.

In one embodiment, the feed gas stream further comprises an additional oxygen source (e.g. a gas containing oxygen such as air). Setting an appropriate oxygen to silicon ratio allows the chemical composition of the film to be adjusted. For example, depending upon the concentration of oxygen as a co-reactant in the plasma, an organo-siloxane may be reduced and deposited in-situ as a silicon suboxide or a silicon dioxide. Further, the residual carbon content of the thin film may be thus controlled. The retention of some carbon produces a thin film having a substantially smooth surface. This reduces the drag between the marker and the writing surface, and allows the marker to easily glide along the writing surface.

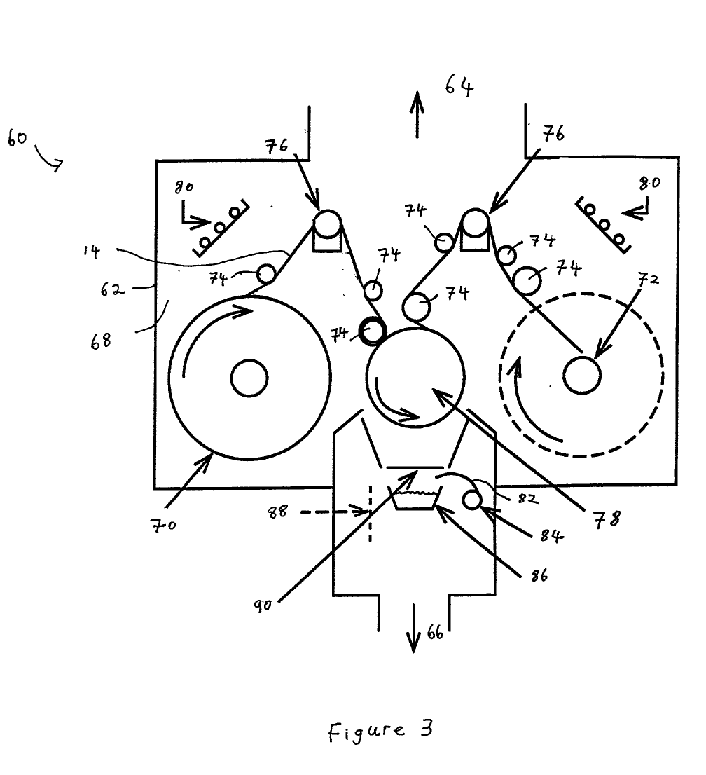

Referring now to FIG. 2, a conventional PECVD system is shown generally at 30. This system utilizes a chamber 32 that is provided with gas feed conduit 52 and gas outlet conduit 48. Typically, the process is run at sub atmospheric pressures. Accordingly, a vacuum pump 44 may be provided downstream from chamber 32 and in flow communication with gas outlet conduit 48. The silicon oxide precursor is provided by feed conduit 46. Typically, the silicon oxide precursor is liquid at atmospheric pressure and at room temperature. Accordingly, the silicon oxide precursor maybe be heated or otherwise treated such that it is gaseous by the time it is introduced to plasma field 50. Optionally, on or more additional gases may be provided to the chamber 32 via feed stream 42. For example, the additional gases may comprise at least one of oxygen, carbon dioxide, argon, methane, nitrogen oxide or hydrogen. For example, silanes may be converted to silicon carbide by adding at least one carbon based process gas to the chamber 32. This may be desirable to increase the carbon content of thin film 12 to reduce the coefficient of friction of thin film 12. Alternatively, siloxanes may be converted to silicon nitrites by adding at least one nitrogen based process gas to the chamber 32. Power supply 40 is connected to magnet 36 by means of wire 38. Magnet 36 is in contact with electrode 34 so as to produce a sub-atmospheric glow discharge plasma in field 50. Substrate 14 is introduced into chamber 32 by any means known in the art. Substrate 14 is provided in flow communication with field 50 such that top surface 16 is exposed to the plasma. Substrate 14 may be moveably positioned in chamber 32 so that an even layer 12 is deposited on to surface 16. In one embodiment, the electric field is a high radio frequency. For example, the radio frequency may be set to about 13.56 MHz. Under these conditions, a ‘quartz-like’ SiOₓ thin 12 film may be easily deposited onto the temperature sensitive substrate 14. In an alternative embodiment, low radio frequency may be used (e.g. 60 Hz to 400 KHz). Power supply 40 may provide either DC or AC current via wire 38 to magnet 36. It is understood that the choice of radio frequency will depend on the specific equipment design and the associated optimum operating parameters.

As discussed previously, in accordance with another embodiment of this invention, thin film 12 may also be deposited onto the first surface 16 of the plastic substrate 14 by physical vapor deposition, also commonly referred to as ‘sputtering’. Sputtering is a physical process wherein a target material (i.e. SiOₓ) is vaporized in a reaction chamber either via an e-beam or an ion beam to produce microscopic fragments that subsequently ‘sputter’ or coat the substrate 14. In this method, the composition of the target is necessarily the composition of the deposited thin film 12.

Referring now to FIG. 3, a typical dual-chamber web coating systems using vacuum evaporation as the deposition process is shown. Other physical (sputtering) deposition processes such as “rowl” or “web” coating systems with a wire-fed thermal vaporization source may be utilized. As shown in FIG. 3, the apparatus is generally referred to by reference numeral 60. The apparatus is provided in housing 62 that has outlets 64 and 66 that are in flow communication with a source of vacuum (such as a vacuum pump) such that the interior 68 of housing 62 is maintained at sub-atmospheric pressure.

Substrate 14 is provided on pay-off spool 70. Substrate 14 travels through a path of rollers and guides 74, including tension sensing roller 76, to capstan 78 wherein thin film 12 is deposited. Thereafter, substrate 14 travels through a path of rollers and guides 74, including tension sensing of roller 76, to wind-up spool 72.

Most film deposition in web coating is done by high-rate thermal evaporation. The evaporation sources are placed close to the substrate requiring high-rate travel of the web. Therefore, means are provided to remove process-generated heat such that substrate 14 is maintained at a temperature below that at which it will be thermally degraded. For example, capstan 78 may be cooled by being in thermal communication with a heat sink. In addition, cryo panels 80 may be provided for cooling at least a portion of interior 68.

The target material 82 may be in the form of a thin strip that is loaded onto a spool 84. At least one evaporator 86 is provided for receiving and evaporating at least a portion of target material 82. Typically, a linear or staggered-linear array of evaporator crucibles is used. The thin strip material is received in evaporator 86 where it is melted for subsequent evaporation. Preferably, electron beam evaporation is utilized for silicon oxide materials. A portion of capstan 78 is provided adjacent evaporator 86 for receiving evaporated target material whereby thin film 12 is formed. A shutter may be provided for isolating evaporator 86 from interior 68. In particular, as shown in FIG. 3, a shutter is shown in the open position by the dashed line denoted by reference numeral 88 and in the closed position by the solid line denoted by reference numeral 90.

While the above description constitutes the preferred embodiments, it will be appreciated that the present invention is susceptible to modification and change without departing from the fair meaning of the proper scope of the accompanying claims.

### EXAMPLES

Writing surfaces were prepared utilizing a high-frequency (13.56 MHz) parallel plate plasma system as well as a drum type low frequency (40-200 Khz) plasma system. The silicon oxide precursor that was fed to the plasma field consisted of hexamethyl disiloxane (HMDSO), argon and oxygen. The resulting PECVD film was a sub oxide of silicon where x was equal to about 1.8.

A writing surface was prepared utilizing an e-beam sputter system. A quartz (SiO₂) target was employed providing a sputtering film of silicon dioxide.

The writing surfaces had eraseability equivalent to or superior to porcelain writing surfaces wherein very little effort was required to erase markings. In those instances where a ghost image remained, it was readily removed with a simple wipe of an alcohol wipe. In addition, pen marks, both erasable as well as permanent markers, left on the PECVD coating for greater than nine months were moved with little or no further effort than fresh marking. Marking from permanent markers were removed with alcohol wipes with no evidence of staining.

1. An erasable marker board having an outer surface which is usable for writing with a dry erasable marker, the board comprising:
(a) a substrate having a first surface and a second surface opposed to the first surface; and,
(b) a thin film of SiOₓ provided on the first surface of the substrate and comprising the outer surface of the board.

2. The erasable marker board as claimed in claim 1 wherein x is <2.

3. The erasable marker board as claimed in claim 1 wherein 1.5<x<2.0.

4. The erasable marker board as claimed in claim 1 wherein the thin film comprises a ceramic.

5. The erasable marker board as claimed in claim 1 wherein the thin film includes carbon.

6. The erasable marker board as claimed in claim 1 wherein at least some of the SiOₓ in the thin film comprises SiOₓC_{y}:H.

7. The erasable marker board as claimed in claim 1 wherein the thin film is prepared by vapor deposition.

8. The erasable marker board as claimed in claim 1 wherein the thin film is prepared by plasma enhanced chemical vapor deposition utilizing a silicon oxide precursor.

9. The erasable marker board as claimed in claim 1 wherein the thin film is prepared by physical vapor deposition utilizing SiO₂ as a target material.

10. The erasable marker board as claimed in claim 1 wherein the carbon content the thin film varies from 5 to about 10 atomic weight percent based on the weight of the thin film.

11. The erasable marker board as claimed in claim 1 wherein the carbon content the thin film varies is about 7 atomic weight percent based on the weight of the thin film.

12. The use of a thin film of SiOₓ as a writing surface of a board.

13. The use as claimed in claim 12 wherein 1.5<x is <2.

14. The use as claimed in claim 12 wherein 1.8<x<2.0.

15. The use as claimed in claim 12 wherein the thin film includes carbon.

16. The use as claimed in claim 12 wherein at least some of the SiOₓ in the thin film comprises SiOₓC_{y}:H.

17. The use as claimed in claim 12 wherein the carbon content the thin film varies from 5 to about 10 atomic weight percent based on the weight of the thin film.

18. The use as claimed in claim 12 wherein the carbon content the thin film varies is about 7 atomic weight percent based on the weight of the thin film.

19. A method of fabricating a erasable marker board having an outer writing surface, the method comprising the steps of:
(a) providing a substrate;
(b) providing a thin ceramic film on the substrate as the outer writing surface of the board.

20. The method as claimed in claim 19 wherein the thin film is produced by vapor deposition.

21. The method as claimed in claim 20 wherein the vapor deposition comprises:
(a) providing at least one feed gas stream comprising at least one silicon oxide precursor;
(b) forming a plasma in an evacuated chamber;
(c) providing the substrate in flow communication with the plasma; and,
(d) flowing the gas stream into the plasma to deposit the thin film onto the substrate wherein the thin film comprises SiOₓ.

22. The method as claimed in claim 21 further comprising providing carbon to the plasma wherein at least some of the SiOₓ is SiOₓC_{y}:H.

23. The method as claimed in claim 21 wherein oxygen oxidizes the silicon oxide precursor and the method further comprises providing oxygen to the plasma to produce a plasma having a concentration of oxygen therein and adjusting the concentration of the oxygen in the plasma to control the extent of oxidation of the silicon oxide precursor.

24. The method as claimed in claim 21 wherein the silicon oxide precursor is one or more of hexamethyldisiloxane, tetramethyidisiloxane and tetramethylsilane.

25. The method as claimed in claim 20 wherein the vapor deposition comprises physical vapor deposition.

26. The method as claimed in claim 25 wherein the vapor deposition comprises:
(a) providing a target material in a chamber;
(b) providing a substrate in the chamber;;
(c) vaporizing at least a portion of the target material to obtain vaporized target material and depositing a thin film of the vaporized target material onto the surface of the substrate thereby forming the top outer writing surface.

27. The method as claimed in claim 25 wherein the target material comprises SiO₂.

28. The method according to claim 26, further comprising passing at least some of the vaporized target material through a plasma field in the presence of a gas prior to the vaporized target material being deposited onto the substrate.

29. The method according to claim 28 wherein the gas is an inert gas.

30. The method according to claim 29 wherein the inert gas is selected from the group consisting of argon, helium, xenon and mixtures thereof.

31. The method according to claim 28 wherein the gas is selected from the group consisting of oxygen, methane, hydrogen, carbon dioxide, nitrogen oxide and mixtures thereof.

32. The method as claimed in claim 19 wherein the carbon content the thin film varies from 5 to about 10 atomic weight percent based on the weight of the thin film.

33. The use as claimed in claim 19 wherein the carbon content the thin film varies is about 7 atomic weight percent based on the weight of the thin film.
